(19) United States
(12) Patent Application Publication
(10) Pub. No.: US 2005/0207141 A1
(43) Pub. Date: Sep. 22, 2005

(54) Drinking vessel

(76) Inventors: Timothy Boesch, Meeker, CO (US); Stephen Chininis, Norcross, GA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/806,532

(22) Filed: Mar. 22, 2004

(51) Int. Cl. F21V 33/00

(52) U.S. Cl. 362/101; 362/96; 362/154

(57) ABSTRACT

A drinking vessel comprises a body having a top, a base and a peripheral wall defining an interior for containing liquid, the base having a compartment that is sealed from the interior. Several light diffusers, each having upper and lower ends, extend along the wall from the base to the top. There are also included respective LEDs for illuminating the light diffusers, which are located in the base compartment in close proximity to the lower ends of the diffusers such that light from the LEDs can enter the diffusers at their lower ends and travel upwards thereby illuminating the entire diffusers.

The present invention relates to a drinking vessel.

### BACKGROUND OF THE INVENTION

Drinking vessels such as cups, mugs and water bottles for example, especially those for kids and sports, can take a large variety of designs, but most of them fall of being novel only in terms of physical appearance.

The invention seeks to provide a drinking vessel that incorporates a light for visual enhancement.

### SUMMARY OF THE INVENTION

According to the invention, there is provided a drinking vessel comprising a body having a top, a base and a peripheral wall upstanding from the base to the top and defining an interior for containing liquid, the base having a compartment that is sealed from the interior. At least one light diffuser having upper and lower ends extends along the wall from the base to substantially the top. There is also included a light source for illuminating said at least one light diffuser, which is located in the base compartment in close proximity to the lower end of the diffuser such that light from the light source can enter the diffuser at its lower end and travel upwards thereby illuminating the entire diffuser.

Preferably, the body includes two said peripheral walls with one surrounding the other, and the light diffuser is located in a gap between the outer and inner walls.

More preferably, the body comprises an inner body including the inner wall and a first base wall together defining the interior, and an outer body including the outer wall and a second base wall, the first and second base walls defining the base compartment therebetween.

Further more preferably, the light diffuser is fixed on the inner wall.

It is preferred that the light diffuser is an integral part of the wall.

In a specific design, the light diffuser is substantially straight and upright.

In a preferred embodiment, the drinking vessel includes a plurality of said light diffusers positioned at intervals around the body, and respective said light sources located in the base compartment for illuminating the light diffusers.

Preferably, the drinking vessel includes a power source located in the base compartment for energizing the light source.

More preferably, the drinking vessel further includes an electronic control circuit located in the base compartment for flashing the light source in a predetermined manner.

Further more preferably, the power source, the control circuit and the light source are all supported by a support.

It is preferred that the drinking vessel includes a power source for energizing the light source and an electronic control circuit for flashing the light source in a predetermined manner, in that the power source, the control circuit and the light source are all supported by a support that is fixed to the first base wall.

### BRIEF DESCRIPTION OF DRAWINGS

The invention will now be more particularly described, by way of example only, with reference to the accompanying drawings, in which:

FIG. 1 is a front elevational view of an embodiment of a drink vessel in accordance with the invention; and

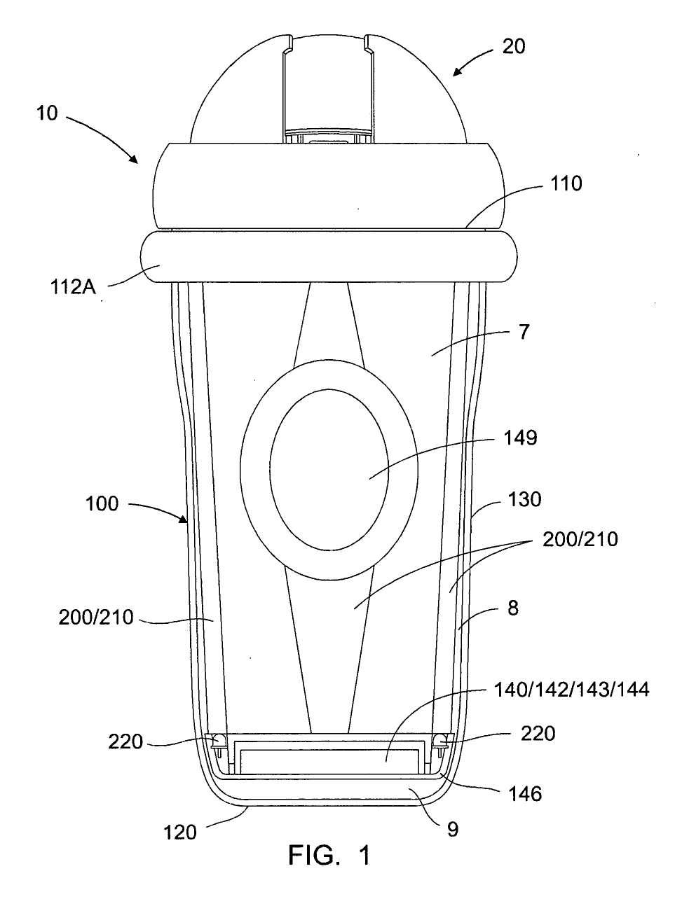

FIG. 2 is a cross-sectional front view of the drink vessel of FIG. 1, showing its various components.

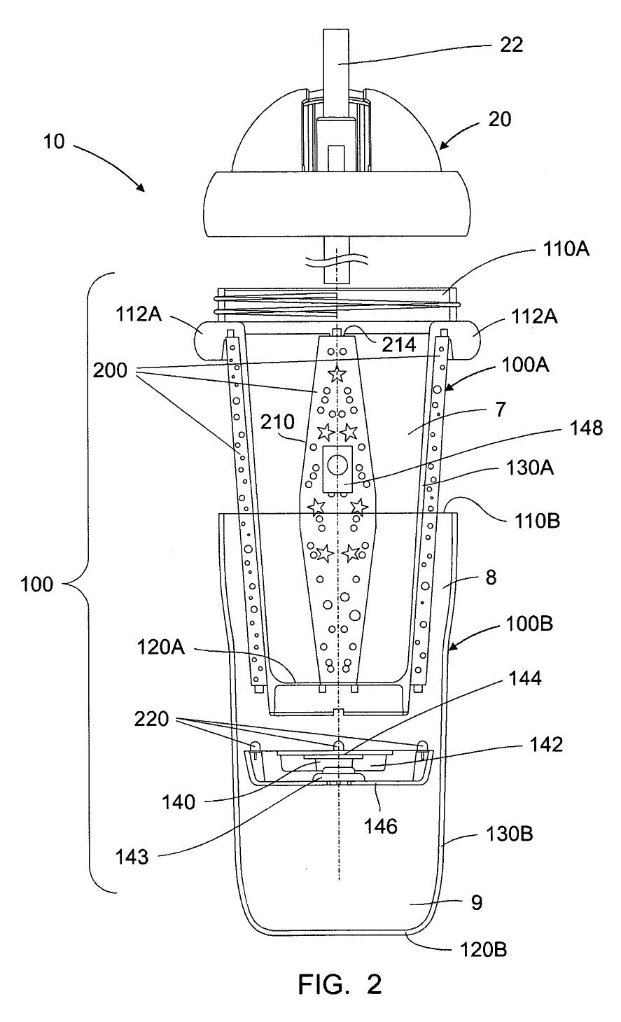

### DETAILED DESCRIPTION OF PREFERRED EMBODIMENT

Referring to the drawings, there is shown a drinking vessel in the form of a sports cup 10 embodying the invention, which comprises a plastics body 100 having an open top 110, a base 120 and a peripheral side wall 130 upstanding from the base 120 to the top 110. The cup body 100 has a waterproof double-walled construction that is formed by an inner body 100A located co-axially within an outer body 100B. Each inner/outer cup body 100A/100B has an open top end 110A/110B (together forming the top 110), a base wall 120A/120B (together forming the base 120) and a peripheral side wall 130A/130B (together forming the side wall 130). The outer side wall 130B is transparent.

The subject cup 10 includes a dome-shaped cap 20 for closing as a water bottle. The cap 20 includes a retractable drinking straw 22 and is screwed onto the inner cup top end 110A.

The inner cup top end 110A has an expanded rim portion 112A that embraces or hooks onto the rim of the outer cup top end 110B and is sealed therewith. The walls 120A and 130A of the inner cup body 100A together define an interior 7 for the overall cup body 100 to contain liquid e.g. a drink or water. The inner and outer base walls 120A and 120B define as between them a compartment 9 in the base 120, which is isolated or sealed from the interior 7 by the inner cup body 100A. The outer side wall 130B surrounds the inner side wall 130A, together forming a cylindrical annular gap 8 between them.

The subject cup 10 includes a number of, i.e. four in the described embodiment, active light bars 200 positioned generally upright at regular intervals around the overall cup side wall 130 for visual or design enhancement. Each light bar 200 is formed by a straight light diffuser 210 (made of a transparent or translucent plastics material for light diffusion) illuminated by a respective light source preferably an LED (light emitting diode) 220 concealed in the base compartment 9.

Each diffuser bar 210 extends from its lower end 212 situated at the cup base 120 vertically along the cup wall 130 to its upper end 214 reaching the cup top 110. More specifically, the diffuser bar 210 is fixed on the outer surface of the inner side wall 130A by glue or being moulded integrally therewith. In the finished product, the diffuser bars 210 are all embedded in the cup wall 130 i.e. located in the gap 8 between the inner and outer side walls 130A and 130B therebetween.

The LEDs 220 are operated by an IC control module 140 that is programmed to flash the LEDs 220 in a certain manner or according to one or more predetermined sequences. The IC module 140 may optionally drive an audio circuit including a piezo-electric speaker 143 for playing a song or music segment/tune that is preferably synchronised with the LED flashing.

The IC module 140 and all the other components of an electronic control circuit tailor-made for the light cup 10, including the speaker 143 and a button cell battery 142 for energizing the LEDs 220, are mounted on a printed circuit board 144, altogether being held in a single flat casing 146. The casing 146 is secured, e.g. by glue, as a cover from below to the base wall 120A of the inner cup body 100A before the inner cup body 100A is inserted into and sealed with the outer cup body 100B, whereby the electronic/electrical components can conveniently be installed in the base compartment 9.

The LEDs 220 are mounted at symmetrical positions on the casing 146 such that they are aligned with and in close proximity to the lower ends 212 of the corresponding diffuser bars 210, or preferably fitted into respective holes therein. The LED light will enter the diffuser bars 210 at their lower ends 212 and then travel upwards along the bars 210 to the upper ends 214, thereby illuminating the entire bars 210. The bars 210 are preferably engraved with patterns for design.

The control circuit may be activated or deactivated by a flat soft touch on/off switch 148 that is provided behind a small panel 149 on the front light bar 200. The panel 149 is made of soft plastic material and is over-moulded with the outer cup wall 130B. The on/off switch 148 is connected to the control circuit in the cup base 120 by thin wires passing through the gap between the back of the front light bar 200 and the side wall 130A of the inner cup 100A that leads to the base compartment 9.

In a basic embodiment, the light bars 200 or the LEDs 220 may blink only upon movement, in which case a control circuit as such is not needed and instead a mechanical motion sensitive or gravity switch may be used to turn the LEDs 220 on and off.

The light cup of the subject invention would be attractive to children or kids in particular or suitable for use in parties or at discotheques or theme parks, etc.

The invention has been given by way of example only, and various other modifications of and/or alterations to the described embodiments may be made by persons skilled in the art without departing from the scope of the invention as specified in the appended claims.

1. A drinking vessel comprising:
a body having a top, a base and a peripheral wall upstanding from the base to the top and defining an interior for containing liquid, the base having a compartment that is sealed from the interior;
at least one light diffuser having upper and lower ends and extending along the wall from the base to substantially the top; and
a light source for illuminating said at least one light diffuser, which is located in the base compartment in close proximity to the lower end of the diffuser such that light from the light source can enter the diffuser at its lower end and travel upwards thereby illuminating the entire diffuser.

2. The drinking vessel as claimed in claim 1, wherein the body includes two said peripheral walls with one surrounding the other, and the light diffuser is located in a gap between the outer and inner walls.

3. The drinking vessel as claimed in claim 2, wherein the body comprises an inner body including the inner wall and a first base wall together defining the interior, and an outer body including the outer wall and a second base wall, the first and second base walls defining the base compartment therebetween.

4. The drinking vessel as claimed in claim 3, wherein the light diffuser is fixed on the inner wall.

5. The drinking vessel as claimed in claim 1, wherein the light diffuser is an integral part of the wall.

6. The drinking vessel as claimed in claim 1, wherein the light diffuser is substantially straight and upright.

7. The drinking vessel as claimed in claim 1, including a plurality of said light diffusers positioned at intervals around the body, and respective said light sources located in the base compartment for illuminating the light diffusers.

8. The drinking vessel as claimed in claim 1, including a power source located in the base compartment for energizing the light source.

9. The drinking vessel as claimed in claim 8, further including an electronic control circuit located in the base compartment for flashing the light source in a predetermined manner.

10. The drinking vessel as claimed in claim 9, wherein the power source, the control circuit and the light source are all supported by a support.

11. The drinking vessel as claimed in claim 3, including a power source for energizing the light source and an electronic control circuit for flashing the light source in a predetermined manner, wherein the power source, the control circuit and the light source are all supported by a support that is fixed to the first base wall.
